(19) United States
(12) Patent Application Publication
(10) Pub. No.: US 2013/0159078 A1
(43) Pub. Date: Jun. 20, 2013

(54) Method and System for Administering a Bank Rewards Program

(71) Applicants: Chad Thomas Peck, West Jordan, UT (US); Coby Don Hafen, Herriman, UT (US)

(72) Inventors: Chad Thomas Peck, West Jordan, UT (US); Coby Don Hafen, Herriman, UT (US)

(21) Appl. No.: 13/327,555

(22) Filed: Dec. 15, 2011

(51) Int. Cl. G06Q 30/02

(52) U.S. Cl. 705/14.17

(57) ABSTRACT

A method and system for administering a rewards program associated with a payment card issued to a customer is provided. The customer's purchase activity with the payment card is monitored and used to award redemption value, or rewards points, to the user in a familiar manner. The customer is permitted to redeem some or all of his or her points to offset specific transactions made using the payment card. The rewards program may also award redemption value for non-purchase activity, such as completing surveys and signing up for additional bank products. In other embodiments, the customer earns redemption value in connection with activity taking place in a first bank account and is permitted to redeem that value in favor of a second bank account.

### BACKGROUND OF THE INVENTION

a. Field of the Invention

The present disclosure relates to banking products. In particular, the present disclosure relates to a customer rewards program associated with one or more banking products.

b. Background Art

Various rewards programs associated with banking products are known. For example, many credit card companies allow the cardholder (also referred to herein as the “customer” or the “user”) to earn reward points (also referred to herein as “redemption value,” or simply as “points”) on purchases, and then redeem these points for merchandise.

Extant banking rewards programs have several disadvantages, however. First, the user is typically limited in the uses he or she can make of his or her points to a pre-defined catalog of merchandise. This undesirably limits the customer's flexibility and freedom of choice when redeeming points, and may result in points expiring prior to redemption.

A somewhat related disadvantage is that the catalog of merchandise may be updated only infrequently. Thus, it may contain obsolete technology or reflect old prices for the merchandise contained therein, leading to sub-optimal redemptions from the customer's perspective.

There are also often inconsistencies between the points redeemed and the value of the limited merchandise for which the points can be redeemed. For example, a user may be required to redeem 160,000 points to receive a laptop computer that retails for $1100, but may need to redeem only 110,000 points to receive $1100 in gift cards to a merchant that sells the computer at retail. This inconsistency may not be readily apparent to the consumer, resulting in consumers redeeming more points (160,000) than necessary (110,000) to purchase a particular item.

Moreover, extant rewards programs often require the bank to pay the program administrator a fee, and this fee is typically passed on to the customer through the number of points he or she must redeem to receive a particular item of merchandise. This further increases the disparity between points redeemed and the value of the merchandise received.

All of the disadvantages of extant rewards programs described above have the potential to result in diminished customer satisfaction with their banks and rewards programs.

### BRIEF SUMMARY OF THE INVENTION

It would therefore be desirable to provide an improved bank rewards program that reduces or eliminates the disadvantages associated with extant bank rewards programs.

It is an object of the present invention to provide a bank rewards program that allows a customer to redeem rewards points with greater flexibility

It is another object of the present invention to provide a bank rewards program that allows a customer to redeem rewards points for specific purchases made using the customer's payment card.

It is yet another object of the present invention to provide a bank rewards program that provides more consistency between points redeemed and the value received therefor.

It is a further object of the present invention to provide a bank rewards program with greater transparency as to the value a customer receives when redeeming rewards points.

Still another object of the present invention is to minimize administrative charges associated with a bank rewards program.

Yet another object of the present invention is to provide a bank rewards program that permits the customer to earn points in connection with one bank product and redeem those points in connection with a second bank account.

Disclosed herein is a system for managing a rewards program associated with a payment card. The system includes an electronic storage medium for storing a plurality of user account records, wherein each user account record is associated with a user and comprises a redemption value balance; a purchase activity monitoring processor that monitors purchase activity using a payment card issued to a user and determines a redemption value associated with the purchase activity; and a balance adjustment processor. The balance adjustment processor adjusts the redemption value balance in the user's account record based on the monitored purchase activity; processes a user's request to redeem at least a portion of the user's redemption value balance to offset at least one selected transaction made with the user's payment card; adjusts the redemption value balance in the user's account record based on the user's redemption of at least a portion of the user's redemption value balance to offset the at least one selected transaction made with the user's payment card; and adjusts the balance on the user's payment card in response to the user's redemption of at least a portion of the user's redemption value balance against to offset the at least one selected transaction made with the user's payment card.

Optionally, the system also includes an advertisement processor programmed to serve user-specific ad content to a user based on the monitored purchase activity. For example, the user-specific ad content can advertise a class of products based on the user having purchased a product from that class using the payment card.

Alternatively, or additionally, the advertisement processor can be programmed to serve user-specific ad content to a user based on the at least one selected transaction that the user offsets via redemption of redemption value balance. For example, the user-specific ad content can advertise a class of products based on the user having redeemed at least a portion of the user's redemption value balance to offset a transaction involving a product from that class.

To allow the customer to redeem points, the system will typically include a computer interface that operably communicates with the balance adjustment processor and that is programmed to accept a user input that represents a selection of at least one transaction to offset via redemption of at least a portion of the user's redemption value balance. The computer interface can be programmed to: display a transaction history for a preselected length of time for the payment card to the user, the transaction history including a plurality of transactions; and receive from the user a selection of one or more transactions in the transaction history that the user wishes to offset via redemption of at least a portion of the user's redemption value balance.

In certain aspects of the invention, the payment card can be a credit card associated with a user credit account. In these aspects of the invention, the balance adjustment processor reduces the balance owed on the user credit account in response to the user's redemption of at least a portion of the user's redemption value balance to offset at least one selected transaction.

In other aspects of the invention, the payment card can be a debit card associated with a user bank account. In these aspects of the invention, the balance adjustment processor increases a balance in the user bank account in response to the user's redemption of at least a portion of the user's redemption value balance to offset at least one selected transaction.

Also disclosed herein is a method of managing a rewards program associated with a payment card issued to a user, including the steps of: establishing, on an electronic storage medium, a user account record associated with the user and comprising a redemption value balance for the user; using a computer to monitor the user's purchase activity associated with use of the payment card; using a computer to award redemption value to the user based on the user's purchase activity; using a computer to monitor the user's redemption value balance; receiving, from the user, a decision to redeem at least a portion of the user's redemption value balance to offset one or more selected transactions made with the payment card; and using the computer to adjust the user's redemption value balance and the balance associated with the payment card in response to the user's decision to redeem at least a portion of the user's redemption value balance to offset one or more selected transactions made with the payment card. The step of receiving, from the user, a decision to redeem at least a portion of the user's redemption value balance to offset one or more selected transactions made with the payment card will generally include: presenting the user with a purchase activity history for a preselected length of time for the payment card, the purchase history including a plurality of entries, each of which represents a single transaction made with the payment card; and receiving from the user a selection of one or more entries in the purchase activity history.

Optionally, the method can include serving user-specific ad content to the user based on at least one of the user's purchase activity with the payment card and a redemption transaction in which the user redeems at least a portion of the user's redemption value balance to offset one or more selected transactions made with the payment card.

It is also contemplated that redemption value can be awarded to the user based on activity other than the user's purchase activity with the payment card, such as completing surveys, participating in social networking, and signing up for additional bank products.

The present invention also provides a system for managing a rewards program associated with a banking product. The system includes an electronic storage medium for storing a plurality of user account records, wherein each user account record is associated with a user and includes a redemption value balance; an activity monitoring processor that monitors the user's activity with respect to a first bank account belonging to the user and determines a redemption value associated with the activity; and a balance adjustment processor. The balance adjustment processor adjusts the redemption value balance in the user's account record based on the monitored activity with respect to the first bank account; processes the user's decision to redeem at least a portion of the user's redemption value balance in favor of a balance in a second bank account belonging to the user; adjusts the redemption value balance in the user's account record based on the user's redemption of at least a portion of the user's redemption value balance in favor of the balance in the second bank account belonging to the user; and adjusts the balance in the second bank account based on the user's redemption of at least a portion of the user's redemption value in favor of the balance in the second bank account belonging to the user.

In certain embodiments, the activity monitoring processor can further monitor the user's activity other than with respect to the first bank account and determine a redemption value associated with the user's activity other than with respect to the first bank account. The balance adjustment processor can, in turn, adjust the redemption value balance in the user's account record based on the monitored activity other than with respect to the first bank account.

The system can optionally include an advertisement processor programmed to serve user-specific content to a user based on the user's redemption of at least a portion of the user's redemption value balance in favor of the balance in the second bank account.

The first bank account and the second bank account can be associated with the same bank, such as a credit card account and a home or auto loan account. Of course, the first and second bank accounts can also be the same account. For example, the first and second user bank account can be a credit account, and the balance adjustment processor can increase the user's redemption value balance in response to purchases made using the credit account and can increase an amount of credit available in the credit account and decrease the user's redemption value balance in response to the user's redemption of at least a portion of the user's redemption value balance in favor of the account balance of the credit account. As another example, the first and second user bank account can be a debit account, and the balance adjustment processor can increase the user's redemption value balance in response to purchases made using the debit account and can increase a balance in the debit account and decrease the user's redemption value balance in response to the user's redemption of at least a portion of the user's redemption value balance in favor of the balance of the debit account.

The system typically includes a computer interface that operably communicates with the balance adjustment processor and that is programmed to permit the user to input a decision to redeem at least a portion of the user's redemption value balance in favor of the balance in the second bank account. The computer interface can be programmed to: display an activity history for the second bank account for a preselected length of time to the user, the activity history including a plurality of entries; and receive from the user a selection of one or more entries in the activity history in favor of which the user wishes to redeem at least a portion of the user's redemption value balance.

An advantage of the present invention is that users are not constrained to a preselected catalog of merchandise when redeeming their reward points.

Another advantage of the present invention is increased uniformity in the value a user receives for redeeming points.

A further advantage of the present invention is increased transparency in the value a user receives for redeeming points.

Yet another advantage of the present invention is that it minimizes administrative charges.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a block diagram of an exemplary system for administering a bank rewards program according to the teachings herein.

FIG. 2 is a screenshot of an illustrative computer interface for allowing a user to redeem rewards points according to the teachings herein.

FIG. 3 is a screenshot of an illustrative confirmation screen associated with a user's redemption of rewards points.

FIG. 4 is a screenshot illustrating certain non-purchase behaviors that can result in additional redemption value being awarded to a user.

### DETAILED DESCRIPTION OF THE INVENTION

The present invention provides an innovative rewards program that allows customers to earn points for purchases and other behaviors (e.g., signing up for electronic billing, patronizing particular merchants, participating in social networking), and then redeem those points with greater flexibility than extant rewards programs (e.g., to offset transactions made with the user's credit card on a transaction-by-transaction basis versus only for the purchase of pre-identified rewards catalog goods and services). That is, unlike prior art rewards programs, which limit the uses to which a user can put his or her reward points, the present invention allows the customer to apply his or her reward points to virtually any banking activity.

For purposes of illustration only, the invention will generally be described in connection with a payment card, such as a debit or credit card, and an associated bank account (e.g., a checking account in the case of a debit card or a credit account in the case of a credit card). (As used herein, the term “debit card” includes prepaid and stored value cards in addition to cards that are directly or indirectly tied to a cardholder's checking and/or savings accounts.) It should be understood, of course, that the teachings herein can be applied to good advantage in other contexts without departing from the spirit and scope of the invention.

The various embodiments of the present invention may be implemented utilizing special purpose and/or general purpose computers, including various computer hardware and software. Much of this hardware and software will be familiar to those of ordinary skill in the art. Thus, the computer hardware and software employed in practicing the present invention will only be described herein to the extent necessary for one of ordinary skill in the art to fully understand and appreciate the invention.

Briefly, the methods herein may be executed by one or more computer systems, and may be software implemented (e.g., one or more software programs executed by one or more computer systems of processors), hardware implemented (e.g., a series of instructions stored in one or more solid state devices), or a combination of both. The computer may be a conventional general purpose computer, a special purpose computer, a distributed computer, or any other type of computer. Further, the computer may comprise one or more processors, such as a single central processing unit or a plurality of processing units, commonly referred to as a parallel processing environment. The term “processor” as used herein refers to a computer microprocessor and/or a software program (e.g., a software module or separate program) that is designed to be executed by one or more microprocessors running on one or more computer systems.

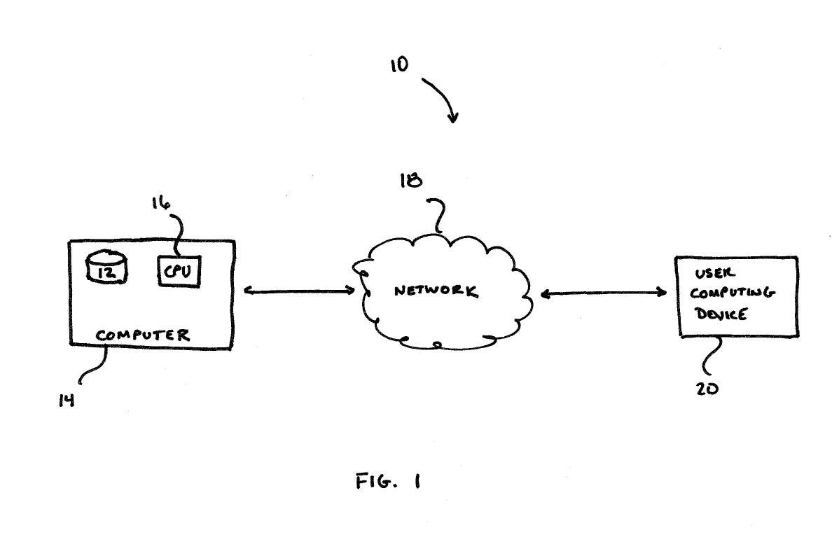

FIG. 1 is a block diagram of a system 10 for managing a rewards program associated with a payment card. System 10 includes an electronic storage medium 12, which may be part of a computer 14, for storing a plurality of user account records. Suitable electronic storage media will be familiar to those of ordinary skill in the art, and include, without limitation, mechanical hard drives, solid state hard drives, RAM, ROM, flash memory devices, optical media (e.g., CDs and DVDs), and the like. Each user account record is associated with a user (e.g., an individual or small business payment card holder) and reflects a redemption value balance (that is, a number of reward points) belonging to that user.

Computer 14 will also typically include a central processing unit (“CPU”) 16. CPU 16 may fulfill the role of various processors to implement the teachings herein. Thus, CPU 16 may function as a purchase activity monitoring processor, a balance adjustment processor, and/or an advertisement processor as further described below.

An activity monitoring processor monitors the user's purchase activity using the payment card and determines a redemption value associated therewith. For example, when the user makes a $100 purchase with his or her credit card, the purchase activity monitoring processor may assign that activity a redemption value of 100 reward points. Conversely, if the user returns goods that result in $100 being credited to the user's credit card, the purchase activity monitoring processor may assign that activity a redemption value of −100 reward points.

Of course, the purchase activity monitoring processor can be programmed to operate according to a variety of rules defining the relationship between purchases and redemption value (i.e., the “earn rate”). For example, the purchase activity monitoring processor can be programmed to award one point per dollar spent for all purchases. The earn rate rules can also be customized, however, in order to encourage or discourage particular customer behaviors, for example by awarding two points per dollar spent on certain purchases as described in further detail below. Other arrangements are also possible (e.g., two points per dollar spent for the first $1000, and one point per dollar thereafter, or two points per dollar spent during a certain specified date range, such as the holiday shopping season).

A balance adjustment processor performs several functions related to keeping accurate track of the user's redemption value balance and the balance of the bank account associated with the user's payment card (e.g., the user's checking account, prepaid balance, or stored value in the case of a debit card or the user's available credit in the case of a credit card). First, the balance adjustment processor is programmed to adjust the redemption value balance in the user's account record based on the monitored purchase activity. For example, where the purchase activity monitoring processor assigns a purchase a redemption value of 100 reward points, the balance adjustment processor increases the user's redemption value balance by 100 reward points and updates the user account record accordingly. Likewise, where the purchase activity monitoring processor assigns a purchase a redemption value of −100 reward points, the balance adjustment processor decreases the user's redemption value balance by 100 reward points and updates the user account record accordingly.

The balance adjustment processor also processes a user's request to redeem reward points. In certain preferred embodiments of the invention, the user redeems reward points to offset user-selected transactions made with the user's payment card; when the user does so, the balance adjustment processor adjusts the user's redemption value balance accordingly. That is, when the user redeems his or her reward points as described in further detail below, the balance adjustment processor makes the required adjustments to the user's redemption value balance and corresponding adjustments to the balance on the user's payment card.

A user may interact with computer 14 to redeem his or her reward points via a network 18, such as the Internet, using a network-connected computing device 20. Computing device 20 may be a desktop computer, a notebook computer, a handheld device (e.g., PDA or smartphone), a tablet device, or any other suitable device.

Using computing device 20, the user may view a computer interface that is in communication (e.g., via network 18) with the balance adjustment processor. The computer interface permits the user to input a decision to redeem at least a portion of the user's redemption value balance in favor of the balance on the user's payment card, for example by allowing the user to select one or more transactions made with the purchase card to offset with rewards points. The computer interface can be implemented as a webpage, which the user may view using an Internet browser installed on computing device 20. Alternatively, the computer interface can be implemented as a stand-alone application installed on computing device 20.

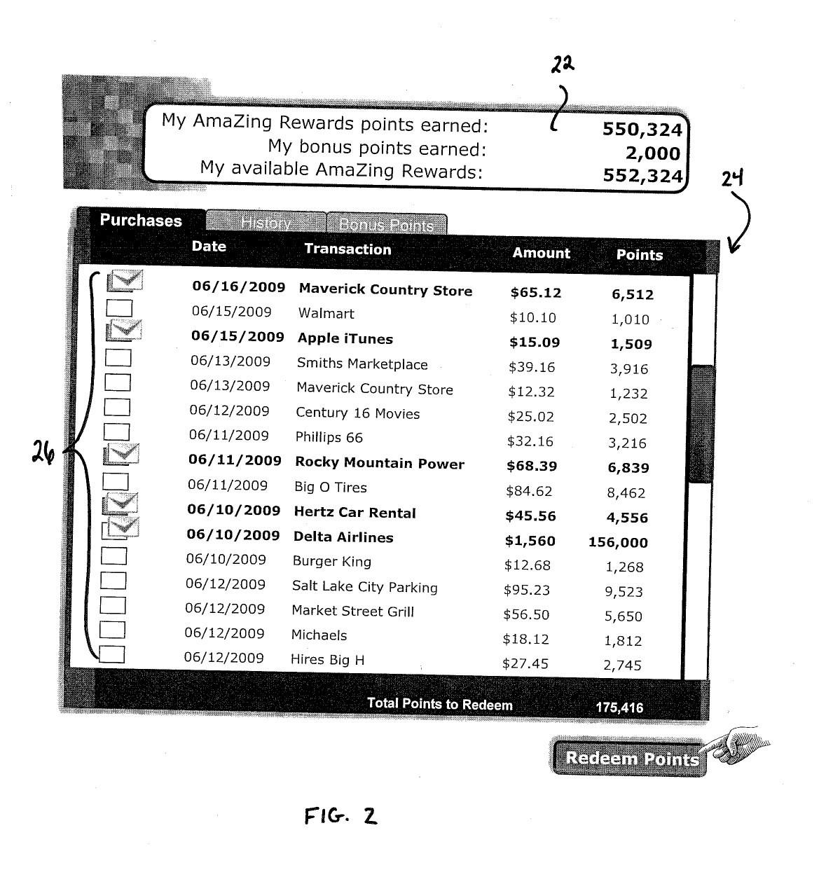

FIG. 2 depicts a representative computer interface. As shown in FIG. 2, the computer interface will typically display the user's redemption value balance 22 and a transaction history 24 spanning a preselected period of time (e.g., a rolling 90 day window). The user can then select, from amongst the various transactions shown in transaction history 24, those transactions that the user wishes to offset with all or some of the user's redemption value balance, for example by ticking check-boxes 26.

Thus, as shown in FIG. 2, the user has a redemption value balance 22 (“My available Reward Yourself points”) of 552,324. The user has selected to redeem a total of 175,400 of these points as follows by ticking the corresponding check-boxes:
Redeem 6,500 points to offset a $65.12 purchase at Maverick Country Store on Jun. 16, 2009;
Redeem 1,500 points to offset a $15.09 purchase at the Apple iTunes store on Jun. 15, 2009;
Redeem 6,800 points to offset a $68.39 purchase at Rocky Mountain Power on Jun. 11, 2009;
Redeem 4,600 points to offset a $45.56 purchase at Hertz Car Rental on Jun. 10, 2009; and
Redeem 156,000 points to offset a $1,560 purchase at Delta Airlines on Jun. 10, 2009.

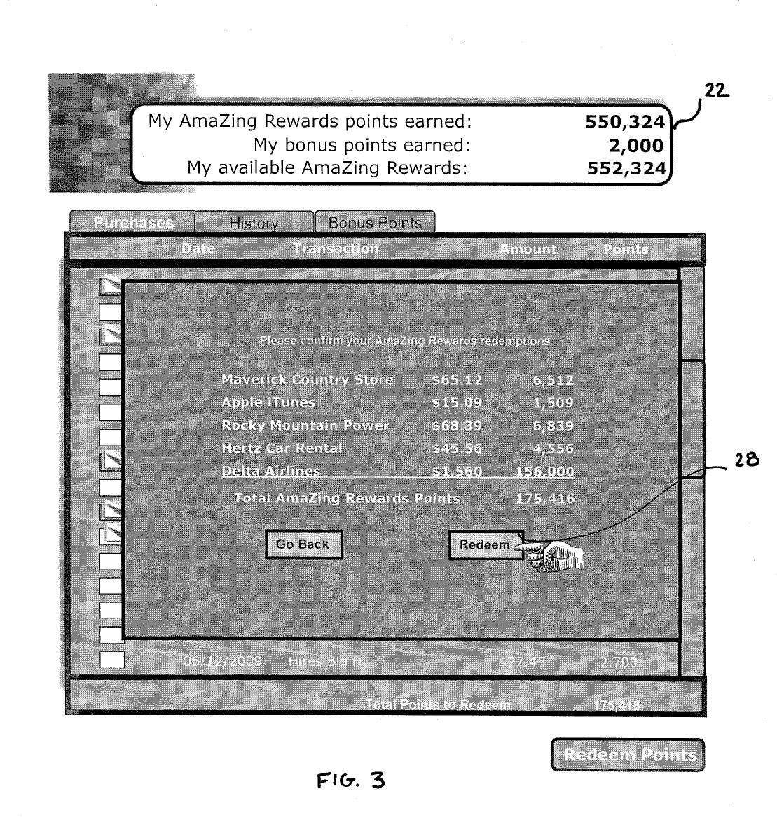

FIG. 3 depicts a confirmation screen that can be presented to the user upon selecting those transactions that the user wishes to offset by redeeming reward points. Upon selecting the “Redeem” button 28, the balance adjustment processor will process the user's selection, deducting 175,400 points from the user's redemption value balance and updating the user's account record accordingly. Correspondingly, the balance adjustment processor will decrease the balance due on the user's credit card, or increase the balance associated with the user's debit card, by $1754.16.

As one of ordinary skill in the art will appreciate from the foregoing disclosure, there is a preselected relationship (i.e., the “exchange rate”) between the number of reward points redeemed and the adjustment made to the user's payment card balance. Just as the earn rate can be implemented via rules enforced by the purchase activity monitoring processor, the exchange rate can be implemented via rules enforced by the balance adjustment processor. For example, as shown in FIGS. 2 and 3, there is approximately a 100:1 relationship between redemption value and payment card balance (i.e., to receive a $1 adjustment to the payment card balance, the user must redeem approximately 100 points).

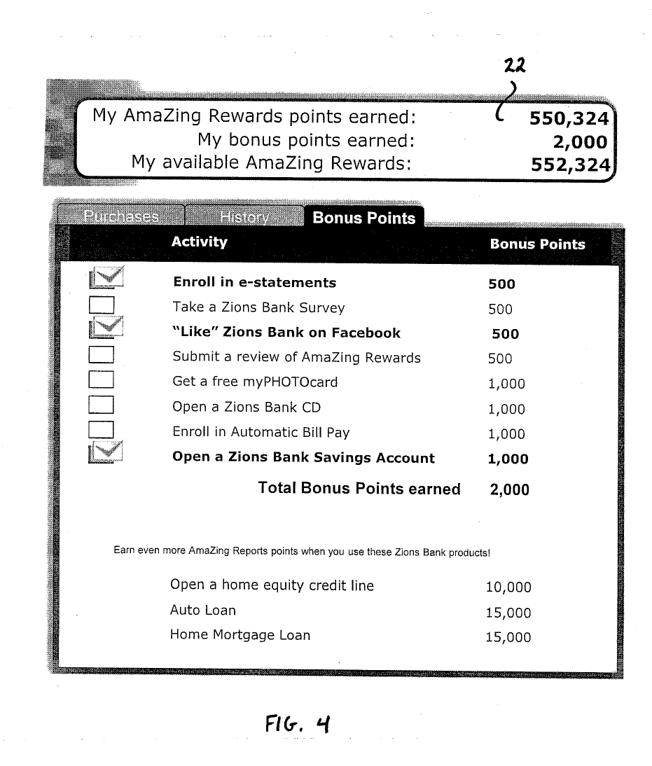

It is also contemplated that the user may earn redemption value for activities other than purchases made with the payment card. Indeed, it is contemplated that additional redemption value can be offered to users in order to incentivize or disincentivize certain behaviors. FIG. 4 depicts several exemplary such activities, including enrolling in e-statements (worth 500 additional reward points), enrolling in automatic bill payment (worth 1000 additional reward points), and opening a savings account with the same bank that provides the payment card (worth 1000 additional reward points).

Of course, other purchase and non-purchase activity can result in additional redemption value in order to encourage (or discourage) particular customer behaviors. For example, the bank may offer additional redemption value via a more favorable earn rate for purchases made at particular merchants or purchases of certain classes of goods and/or services. Thus, for example, double redemption value (e.g., two points per dollar spent) can be offered for purchases made at particular gas stations (e.g., all Shell stations) or for all gasoline purchases regardless of brand.

In yet another aspect of the invention, the user's monitored purchase activity and/or the user's redemption activity can be used to serve user specific ad content via a suitably programmed advertisement processor. For example, targeted advertisements may be displayed to the user when the user logs on to the customer interface or emailed to the user periodically. These advertisements can be a reflection of the user's purchase activity (e.g., if the user frequently purchases tickets to sporting events, the system may display an advertisement for an upcoming sporting event). Alternatively, or additionally, the advertisements can be a reflection of the user's redemption activity (e.g., if the user frequently redeems value to offset transactions taking place at dining establishments, the system may display an advertisement for a new restaurant).

The targeted advertisement aspect of the present invention can be combined to good advantage with the adjustments to earn rates and exchange rates described above. For example, suppose a particular electronics store wants to increase its business. It can partner with a bank offering a rewards program according to the teachings herein to (1) target advertisements to bank customers that make numerous and/or substantial purchases at electronics stores; (2) offer a more favorable earn rate; and/or (3) offer a more favorable exchange rate.

It is also contemplated that the customer may earn redemption value for activity taking place on one account (referred to herein as a “first bank account”) and be allowed to redeem that redemption value for activity taking place on another account (referred to herein as a “second bank account”), particularly (but not necessarily) where both the first and second bank accounts are held at the same bank. Thus, for example, a user may earn redemption value for credit card purchases and be allowed to redeem that value to pay down a home or auto loan.

Although several embodiments of this invention have been described above with a certain degree of particularity, those skilled in the art could make numerous alterations to the disclosed embodiments without departing from the spirit or scope of this invention.

For example, the present invention can be implemented in connection with a bank's Internet- or mobile-banking offerings. Alternatively, the present invention can be implemented as an adjunct to a bank's more traditional branch-banking offerings.

As another example, the present invention may offer additional options to a user seeking to redeem all or some of the user's redemption value balance, such as gift cards for various goods and/or services, charitable contributions, or transfers of redemption value to others.

As a further example, just like certain spending behaviors can be incentivized by modifying the rules applicable to earning redemption value, certain redemption behaviors can be incentivized by modifying the rules applicable to redeeming value.

As yet another example, the user's redemption of a portion of his or her redemption value may reflect a surcharge charged to the bank by a third-party provider for administering the rewards program on the bank's behalf.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A system for managing a rewards program associated with a payment card, the system comprising:
an electronic storage medium for storing a plurality of user account records, wherein each user account record is associated with a user and comprises a redemption value balance;
a purchase activity monitoring processor that monitors purchase activity using a payment card issued to a user and determines a redemption value associated with the purchase activity; and
a balance adjustment processor that
adjusts the redemption value balance in the user's account record based on the monitored purchase activity;
processes a user's request to redeem at least a portion of the user's redemption value balance to offset at least one selected transaction made with the user's payment card;
adjusts the redemption value balance in the user's account record based on the user's redemption of at least a portion of the user's redemption value balance to offset the at least one selected transaction made with the user's payment card; and
adjusts the balance on the user's payment card in response to the user's redemption of at least a portion of the user's redemption value balance against to offset the at least one selected transaction made with the user's payment card.

2. The system according to claim 1, further comprising an advertisement processor programmed to serve user-specific ad content to a user based on the monitored purchase activity.

3. The system according to claim 2, wherein the user-specific ad content advertises a class of products based on the user having purchased a product from that class using the payment card.

4. The system according to claim 1, further comprising an advertisement processor programmed to serve user-specific ad content to a user based on the at least one selected transaction that the user offsets via redemption of redemption value balance.

5. The system according to claim 4, wherein the user-specific ad content advertises a class of products based on the user having redeemed at least a portion of the user's redemption value balance to offset a transaction involving a product from that class.

6. The system according to claim 1, further comprising a computer interface that operably communicates with the balance adjustment processor and that is programmed to accept a user input that represents a selection of at least one transaction to offset via redemption of at least a portion of the user's redemption value balance.

7. The system according to claim 6, wherein the computer interface is programmed to:
display a transaction history for a preselected length of time for the payment card to the user, the transaction history comprising a plurality of transactions; and
receive from the user a selection of one or more transactions in the transaction history that the user wishes to offset via redemption of at least a portion of the user's redemption value balance.

8. The system according to claim 1, wherein the payment card is a credit card associated with a user credit account and wherein the balance adjustment processor reduces the balance owed on the user credit account in response to the user's redemption of at least a portion of the user's redemption value balance to offset at least one selected transaction.

9. The system according to claim 1, wherein the payment card is a debit card associated with a user bank account and wherein the balance adjustment processor increases a balance in the user bank account in response to the user's redemption of at least a portion of the user's redemption value balance to offset at least one selected transaction.

10. A method of managing a rewards program associated with a payment card issued to a user, the method comprising:
establishing, on an electronic storage medium, a user account record associated with the user and comprising a redemption value balance for the user;
using a computer to monitor the user's purchase activity associated with use of the payment card;
using a computer to award redemption value to the user based on the user's purchase activity;
using a computer to monitor the user's redemption value balance;
receiving, from the user, a decision to redeem at least a portion of the user's redemption value balance to offset one or more selected transactions made with the payment card; and
using the computer to adjust the user's redemption value balance and the balance associated with the payment card in response to the user's decision to redeem at least a portion of the user's redemption value balance to offset one or more selected transactions made with the payment card.

11. The method according to claim 10, further comprising serving user-specific ad content to the user based on at least one of the user's purchase activity with the payment card and a redemption transaction in which the user redeems at least a portion of the user's redemption value balance to offset one or more selected transactions made with the payment card.

12. The method according to claim 10, wherein the step of receiving, from the user, a decision to redeem at least a portion of the user's redemption value balance to offset one or more selected transactions made with the payment card comprises:
presenting the user with a purchase activity history for a preselected length of time for the payment card, the purchase history comprising a plurality of entries, each of which represents a single transaction made with the payment card; and
receiving from the user a selection of one or more entries in the purchase activity history.

13. The method according to claim 10, further comprising awarding redemption value to the user based on activity other than the user's purchase activity with the payment card.

14. A system for managing a rewards program associated with a banking product, the system comprising:
an electronic storage medium for storing a plurality of user account records, wherein each user account record is associated with a user and comprises a redemption value balance;
an activity monitoring processor that monitors the user's activity with respect to a first bank account belonging to the user and determines a redemption value associated with the activity; and
a balance adjustment processor that
adjusts the redemption value balance in the user's account record based on the monitored activity with respect to the first bank account;
processes the user's decision to redeem at least a portion of the user's redemption value balance in favor of a balance in a second bank account belonging to the user;
adjusts the redemption value balance in the user's account record based on the user's redemption of at least a portion of the user's redemption value balance in favor of the balance in the second bank account belonging to the user; and
adjusts the balance in the second bank account based on the user's redemption of at least a portion of the user's redemption value in favor of the balance in the second bank account belonging to the user.

15. The system according to claim 14, wherein:
the activity monitoring processor further monitors the user's activity other than with respect to the first bank account and determines a redemption value associated with the user's activity other than with respect to the first bank account; and
the balance adjustment processor further adjusts the redemption value balance in the user's account record based on the monitored activity other than with respect to the first bank account.

16. The system according to claim 14, further comprising an advertisement processor programmed to serve user-specific content to a user based on the user's redemption of at least a portion of the user's redemption value balance in favor of the balance in the second bank account.

17. The system according to claim 14, wherein the first bank account and the second bank account are associated with the same bank.

18. The system according to claim 17, wherein the first bank account and the second bank account are the same.

19. The system according to claim 18, wherein:
the first and second user bank account is a credit account;
the balance adjustment processor increases the user's redemption value balance in response to purchases made using the credit account; and
the balance adjustment processor increases an amount of credit available in the credit account and decreases the user's redemption value balance in response to the user's redemption of at least a portion of the user's redemption value balance in favor of the account balance of the credit account.

20. The system according to claim 18, wherein:
the first and second user bank account is a debit account;
the balance adjustment processor increases the user's redemption value balance in response to purchases made using the debit account; and
the balance adjustment processor increases a balance in the debit account and decreases the user's redemption value balance in response to the user's redemption of at least a portion of the user's redemption value balance in favor of the balance of the debit account.

21. The system according to claim 14, further comprising a computer interface that operably communicates with the balance adjustment processor and that is programmed to permit the user to input a decision to redeem at least a portion of the user's redemption value balance in favor of the balance in the second bank account.

22. The system according to claim 21, wherein the computer interface is programmed to:
display an activity history for the second bank account for a preselected length of time to the user, the activity history comprising a plurality of entries; and
receive from the user a selection of one or more entries in the activity history in favor of which the user wishes to redeem at least a portion of the user's redemption value balance.
